(19) United States
(12) Patent Application Publication
(10) Pub. No.: US 2006/0007146 A1
(43) Pub. Date: Jan. 12, 2006

(54) Electrodes touching mouse

(75) Inventor: Bill Huang, Taipei (TW)

Correspondence Address: BACON & THOMAS, PLLC, 625 SLATERS LANE, FOURTH FLOOR, ALEXANDRIA, VA, 22314, US

(73) Assignee: Chic Technology Corp., Taipei (TW)

(21) Appl. No.: 10/867,720

(22) Filed: Jun. 16, 2004

(51) Int. Cl. G09G 5/08

(52) U.S. Cl. 345/163

(57) ABSTRACT

The present invention relates to a kind of electrodes touching mouse, especially one using the electrostatic induction caused by the finger pressure to operate the mouse function keys. The present invention consists of four conducting surfaces and an inner metal point wherein the four conducting surfaces represent the left, right, upper roller and down roller keys respectively operated by the static electricity emitted by the finger. The inner metal point is connected to the mouse circuit for reading of the circuit signal produced by the finger in touch with the conducting surface. Hence, the present invention provides a modern and original structure of adjoining key buttons using electric induction as power source. This structure is also dust and waterproof and makes no mechanical noise when in use.

### BACKGROUND OF THE INVENTION

1. Field of the Invention

The present invention relates to a kind of electrodes touching mouse, especially one using the electrostatic induction caused by the finger pressure to operate the mouse function keys.

2. Description of the Related Art

The key buttons of the commonly used desktop mouse are mechanically manufactured and are designed with a spring inside the machine body and there is a gap in-between the key buttons. This is very unpleasant to the user as a mechanical noise is emitted while pressing the keys and some dust or other residue can be left in-between the gaps, thus influencing proper function of the mouse.

### SUMMARY OF THE INVENTION

The present invention relates to a kind of electrodes touching mouse mainly consisting of four conducting surfaces and an inner metal point wherein the four conducting surfaces represent the left, right, upper roller and down roller keys of the mouse respectively operated by the static electricity emitted by the finger. The key surface has a smooth surface and is not separated such that there is no gap in-between the key buttons.

The present invention relates to a kind of electrodes touching mouse wherein one edge of the inner metal point is connected to the inner circuit of the mouse and the other end is used for reading of circuit signal produced by the finger in touch with the conducting surface.

### A BRIEF DESCRIPTION OF DRAWINGS

FIG. 1 shows a plan of the outward appearance of the present invention.

FIG. 2 shows a plan of the inner pressing points of the present invention.

FIG. 3 shows a plan of the principles of the present invention.

FIG. 4 shows a plan of the principles of the touch control circuit.

### DETAILED DESCRIPTION OF THE INVENTION

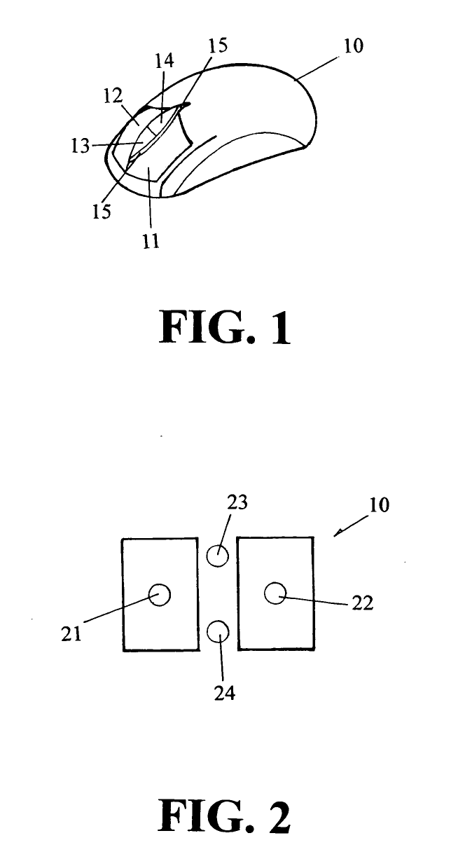

With reference to FIG. 1 showing a plan of the outward appearance of the present invention, the present mouse 10 is almost similar to the commonly used mouse. As usual, there is a left key 11, right key 12 but the roller of roller space 15 is substituted by upper roller key 13 and down roller key 14 designed in one whole surface without any gaps in-between the keys. This special structure is the most modern and original design of the present invention being at the same time dust-proof as well as waterproof.

With reference to FIG. 2 showing a plan of the inner pressing points of the present invention, the left key metal point 21, right key metal point 22, upper pressing metal point 23 and down pressing metal point 24 are connected to the inner circuit of the mouse 10 at the bottom edge and the upper edge is used for reading of circuit signal produced by the finger 32 in touch with the conducting surface 31. (Please further refer to diagram 3).

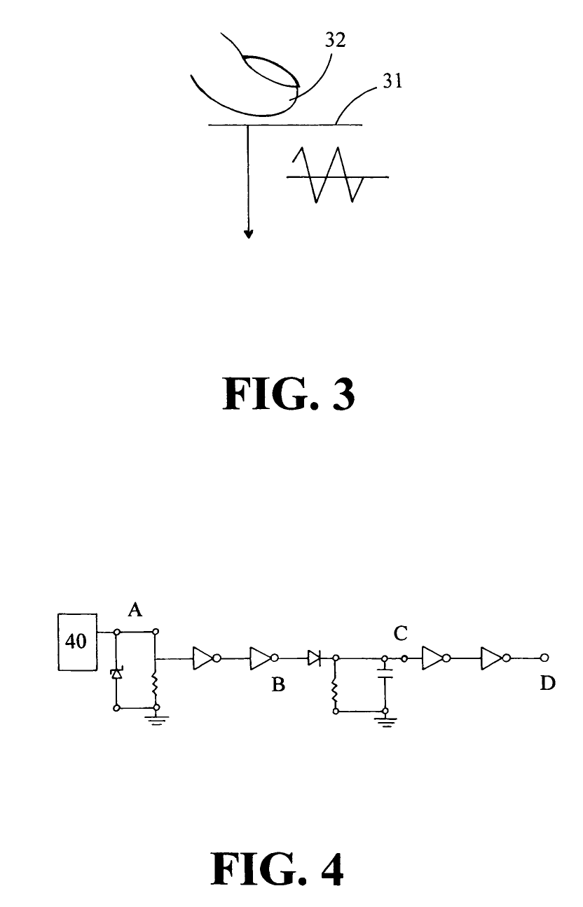

With reference to FIG. 3 showing a plan of the principles of the present invention and further reference to FIGS. 1 and 2, the control key surface of the mouse 10 consists of a conducting surface 31 and when the finger 32 touches the left key 11, the conducting surface directly induces the static electricity of finger 32 to the left key metal point 21 for reading of circuit signal produced by the finger 32 in touch with the conducting surface 31. The same principle also applies to the other keys and the right key 12 will not be influenced by the left key 11 due to appropriate conducting distance.

With reference to FIG. 4 showing a plan of the principles of the touch control circuit, said circuit route is divided into four different points namely A, B, C and D whereby point A is of high input impedance with low noise when untouched and no square waves will be emitted by point B while the output of point D is LOW. When the conducting surface 40 is being touched, point A will immediately sense an alternating current of 60 Hz while point B emits square waves of 60 Hz passing through point C for current rectification resulting in a HIGH output at point D. When touch pressure is released, point A is back to the original low noise status. Hence, the change of output in point D (HIGH when being touched and LOW when released) forms a group of touch control circuit. Further, the present invention provides a modern and original structure of adjoining key buttons using electric induction as power source. This structure is also dust and waterproof and makes no mechanical noise when in use.

1. A kind of electrodes touching mouse mainly consisting of four conducting surfaces and an inner metal point, wherein:
the four conducting surfaces represent by the left key, right key, upper roller key and down roller key respectively operated by the static electricity emitted by the finger, the key surface has a smooth surface and is not separated such that there is no gap in-between the key buttons;
one edge of the inner metal point is connected to the inner circuit of the mouse and the other end is used for reading of circuit signal produced by the finger in touch with the conducting surface, as characterized.

2. A kind of electrodes touching mouse according to claim 1, wherein said the inner circuit route is divided into four different points namely a, b, c and d whereby point a is of high input impedance with low noise when untouched and no square waves will be emitted by point b while the output of point d is low; when the conducting surface is being touched, point a will immediately sense an alternating current of 60 Hz while point b emits square waves of 60 Hz passing through point c for current rectification resulting in a high output at point d; when touch pressure is released, point a is back to the original low noise status; hence, the change of output in point d (high when being touched and low when released) forms a group of touch control circuit.
